(19) United States
(12) Patent Application Publication
(10) Pub. No.: US 2004/0190726 A1
(43) Pub. Date: Sep. 30, 2004

(54) Audio output control circuit

(76) Inventor: Hiroyuki Imadate, Takefu-city (JP)

Correspondence Address: FLYNN THIEL BOUTELL & TANIS, P.C., 2026 RAMBLING ROAD, KALAMAZOO, MI, 49008-1699, US

(21) Appl. No.: 10/796,939

(22) Filed: Mar. 9, 2004

(30) Foreign Application Priority Data
Mar. 25, 2003 (JP) 2003-083615

(51) Int. Cl. H04H 5/00; H04B 3/00

(52) U.S. Cl. 381/11; 381/77; 381/307

(57) ABSTRACT

The invention intends to provide an audio output control circuit capable of reproducing the audio signals inputted to the external input terminals in the multi-channel audio reproduction system with a simplified circuit configuration. The control circuit furnishes the external input terminals with a detection circuit composed of a switch for electrically connecting both of the external input terminals, and a switch circuit. The switch is in a connection state in the normal condition, but when a plug is inserted into the one of the terminals, the switch is made disconnected. When the plug is inserted only into the other one of the terminals, and the monaural signal is inputted, the same monaural signal is outputted from the two terminals. The switch circuit being put in ON and OFF by a current from the other one of the terminals detects the insertion state of a plug.

### BACKGROUND OF THE INVENTION

1. Field of the Invention

The present invention relates to an audio output control circuit used in the audio reproduction system using multi-channels such as the 5.1 channels.

2. Description of the Related Art

Accompanied with the recent trend in the practical use of large-capacity information recording/reproducing devices such as DVDs and HDDs, the speeding up of information processing has been progressing, and the digital processing technique of video and audio information has been spreading. With regard to the audio information, the audio output technique using multi-channels has been developed in order to enhance presence. For example, the audio reproduction system by the 5.1 channels provides a user with two speakers for the front channels, two speakers for the rear channels, one speaker for the front center channel, and one sub-woofer for emitting sub-audible sounds, in a state that these five speakers plus one surround the user. The system gives the user the audio outputs freely adjustably from each of these speakers, so that the user can have the feeling of such powerful presence that the voices and sounds move around right and left, front and rear.

However, the TV broadcasting, FM broadcasting, and VCRs handle the two-channel audio stereo-outputs in most cases. Accordingly, it is preferred that these stereo-outputs become possible of being outputted in the above multi-channel audio reproduction system. It is also advisable to prepare an arrangement that allows the connection of a separate reproduction device such as a cassette tape recorder to external input terminals and the input of the audio signals.

In order to meet these demands, Patent Reference 1 of JP-A 4-207299 discloses a wide/surround automatic switching circuit. This switching circuit inputs audio signals inputted from the external input terminals to a differential amplifier, controls a switching circuit by a detection signal from the differential amplifier, switches an output mode into a quasi-stereo mode when a monaural signal is inputted, and switches the output mode into a surround-sound mode when stereo signals are inputted. Further, Patent Reference 2 of JP-A 5-199599 discloses the following points: inputting audio signals for an R channel and L channel to a stereo-sound field expanding device and a monaural-sound field expanding device to add the surrounding effect, discriminating the stereo/monaural mode in a stereo/monaural automatic switching device on the basis of the differential signal of the R and L outputted from the stereo-sound field expanding device, and supplying the speakers with the outputs from the corresponding sound field expanding device.

With regard to the connection to the external input terminals, Patent Reference 2 of JP-A 5-292427 discloses the following points: providing an interlock switch for setting the monaural mode to one external input terminal, providing an interlock switch for discriminating the external input to the other external input terminal, making both of the interlock switches open-circuited when connection terminals are inserted into both of the external input terminals, thereby outputting audio signals independently from each of the external input terminals, and making only the interlock switch for discriminating the external input open-circuited when the connection terminal is inserted into the other external input terminal only, thereby outputting the same audio signals from both of the external input terminals.

Both of the Patent References 1 and 2 discriminate the externally inputted audio signals whether they are the stereo signals or the monaural signal by using the audio signals, and execute the signal processing corresponding to the signals each. Accordingly, both of them require such circuits as differential amplifiers, adders, subtracters, etc., for discriminating the audio signals, which consequently complicates the circuit configuration and increases a burden of cost. Especially in the TV broadcasting systems, and FM broadcasting systems, the audio demodulation circuit detects whether the audio signals are the stereo signals or the monaural signal. Therefore, it is not necessary to discriminate the signals, after being outputted as the audio signals for the R channel and L channel. Also in the VCRs, since the reproduction circuit detects the type of the signal, the discrimination is unnecessary as well. In a word, it is necessary to detect which type the externally inputted audio signals belong to; however, it is hardly adoptable to provide the circuit configurations as disclosed in the Patent References 1 and 2 in view of the effect-against-cost basis. Also, the circuit for the external input terminals as disclosed in the Patent Reference 3 is configured complicatedly as well, which is quite possible of increasing a burden of cost.

### SUMMARY OF THE INVENTION

It is accordingly an object of the invention to provide an audio output control circuit with a simplified circuit configuration that makes it possible to reproduce the audio signals inputted to the external input terminals in the multi-channel audio reproduction system.

According to one aspect of the invention, the audio output control circuit includes: two external input terminals each corresponding to the R channel and L channel, a detection circuit that detects an insertion state of a plug into one terminal of the external input terminals, a surround-processing circuit that processes audio signals outputted from the external input terminals so as to be reproducible in a surround-sound field, and a control circuit that controls the audio signals from the external input terminals in response to a detection signal from the detection circuit, so that the surround-processing circuit processes the audio signals in a stereo mode or a monaural mode.

According to another aspect of the invention, the audio output control circuit includes: plural types of stereo signal output circuits that output R-channel and L-channel audio signals, two external input terminals each corresponding to the R channel and L channel, a detection circuit that detects an insertion state of a plug into one terminal of the external input terminals, a surround-processing circuit that processes the R-channel and L-channel audio signals so as to be reproducible in a surround-sound field, a two-channel signal switching circuit that switches the audio signals outputted from the stereo signal output circuits or the external input terminals to output to the surround-processing circuit, and a control circuit that controls to switch the two-channel signal switching circuit in response to a selection signal for selecting either of outputs from the stereo signal output circuits and the external input terminals, and that controls the audio signals from the external input terminals in response to a detection signal from the detection circuit, so that the surround-processing circuit processes the audio signals in a stereo mode or a monaural mode.

According to another aspect of the invention, the audio output control circuit includes plural types of stereo signal output circuits that output R-channel and L-channel audio signals, two external input terminals each corresponding to the R channel and L channel, a detection circuit that detects an insertion state of a plug into one terminal of the external input terminals, a multi-channel signal output circuit that outputs audio signals corresponding to multi-channels, a surround-processing circuit that processes the audio signals outputted from the stereo signal output circuits or the external input terminals so as to be reproducible in a surround-sound field, a two-channel signal switching circuit that switches the audio signals outputted from the stereo signal output circuits or the external input terminals to output to the surround-processing circuit, a multi-channel signal switching circuit that outputs to switch the audio signals outputted from the multi-channel signal output circuit or the surround-processing circuit, and a control circuit that controls the two-channel signal switching circuit and the multi-channel signal switching circuit in response to a selection signal for selecting any of outputs from the stereo signal output circuits, the external input terminals, and the multi-channel signal output circuit, and that controls the audio signals from the external input terminals in response to a detection signal from the detection circuit, so that the surround-processing circuit processes the audio signals in a stereo mode or a monaural mode.

Further, the audio output control circuit may include a switch between the two external input terminals, which normally puts the two terminals electrically into a connection state, and disconnects the terminals to interlock with the insertion of a plug into one of the terminals. And, when the plug is inserted into the other terminal only, a monaural signal from the outside is outputted from the two terminals as the audio signals. Further, the detection circuit may detect a connection or disconnection of the switch.

As being provided with the above configurations, the audio output control circuit of the invention detects the insertion state of a plug into one of the external input terminals, and executes a control such that the surround-processing circuit processes the inputted audio signals in the stereo mode or the monaural mode. Thereby, the control circuit is able to reproduce the audio signals inputted to the external input terminals with the extremely simplified configuration in the multi-channel audio reproduction system. In other words, the control circuit of the invention saves differential circuits and so forth, and achieves a reliable reproduction processing in the stereo mode or monaural mode only with the detection circuit that detects the insertion state of a plug into one of the external input terminals, while reducing a burden of cost.

Further, the control circuit contains the switch connected between the two external input terminals, which normally puts the two terminals into the connection state, and disconnects the terminals to interlock with the insertion of a plug into one of the terminals. When the plug is inserted into the other terminal only, the switch maintains the connection state electrically. Accordingly, the monaural signal from the outside is outputted from the two terminals as the audio signals. And, when the plugs are inserted into each of the two terminals, the switch is disconnected. Accordingly, the audio signals are outputted independently from each of the two terminals. In this manner, the audio output control circuit with a very simple circuit configuration of one switch is capable of outputting each of the audio signals inputted to the external input terminals as the audio signals for the R channel and L channel, when the signals are the stereo signals, and outputting the same audio signal as the audio signals for the R channel and L channel, when the signals are the monaural signal.

Provided that the detection circuit includes an arrangement of detecting the connection and disconnection of the switch, the circuit configuration can be simplified furthermore. Since the input of the monaural signal is detected by the connection of the switch, and the input of the, stereo signals is detected by the disconnection of the switch, it is possible to surely identify the type of the audio signals inputted to the external input terminals.

### BRIEF DESCRIPTION OF THE DRAWINGS

FIG. 1 illustrates the circuit configuration of an embodiment according to the invention;

FIG. 2 illustrates circuit configurations relating to the audio signal processing in the surround-processing circuit; and

FIG. 3 illustrates the processing flow of the embodiment according to the invention.

### DETAILED DESCRIPTION OF THE PREFERRED EMBODIMENTS

The preferred embodiments according to the invention will be described in detail with reference to the accompanying drawings. The embodiments now being described are concrete examples, which are preferred to implement the invention; therefore, several technical confinements are given to the embodiments. However, as long as the descriptions hereunder do not clearly mention that these confinements are related with the present invention, it should be understood that the invention is not confined to these embodiments.

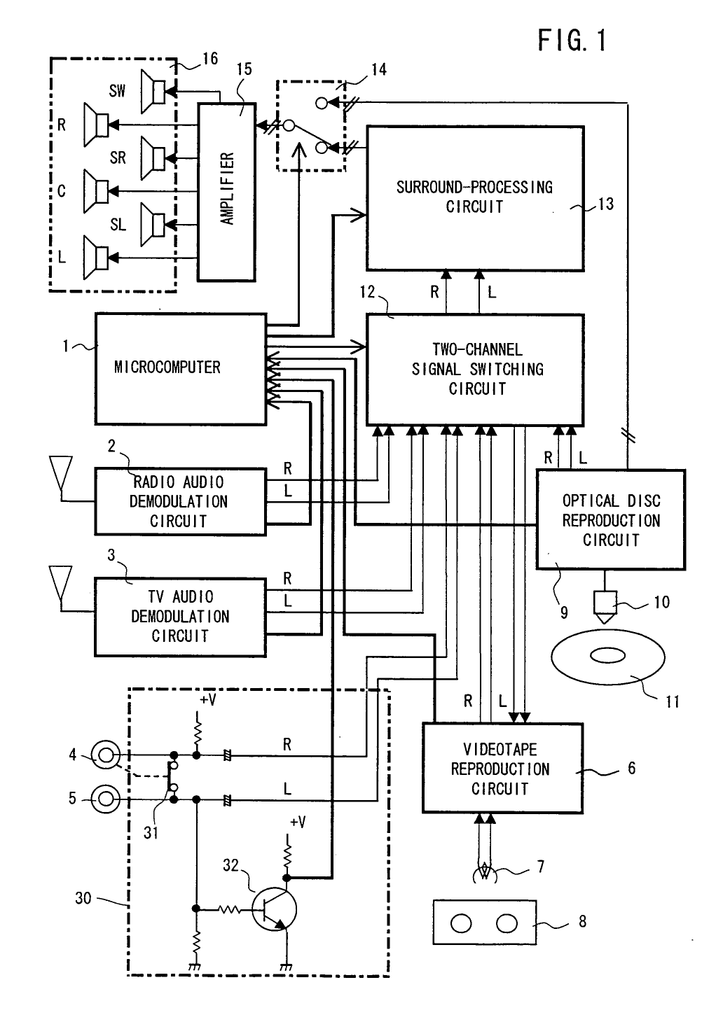

FIG. 1 illustrates the circuit configuration of an embodiment according to the invention. The circuit includes a microcomputer 1 as a control circuit that executes information processing for the control, a radio audio demodulation circuit 2 that demodulates audio signals from the reception signals of FM and AM broadcasting, a TV audio demodulation circuit 3 that demodulates audio signals from the reception signals of TV broadcasting, a videotape reproduction circuit 6 that reproduces audio signals based on the signals being read from a video cassette 8 through a magnetic head 7, as output circuits of the audio signals for the R channel and L channel.

An optical disc reproduction circuit 9 reproduces audio signals based on the signals being read from an optical disc 11 such as DVDs or CDs through a pickup 10. The reproduction circuit 9 outputs to reproduce the audio signals for the R channel and L channel when the two-channel audio signals are recorded in the optical disc 11, and outputs to reproduce the multi-channel audio signals when the audio signals for the multi-channels such as 4 or 5.1 channels are recorded in the optical disc 11. Thus, the optical disc reproduction circuit 9 functions as the two-channel signal output circuit and the multi-channel signal output circuit.

When the stereo signals are inputted to external input terminals 4 and 5 from the outside, the R-channel audio signal is inputted to the terminal 4, and the L-channel audio signal is inputted to the terminal 5. And, the monaural signal is inputted to the terminal 5.

The two-channel audio signals for the R channel and L channel that are outputted from the radio audio demodulation circuit 2, TV audio demodulation circuit 3, videotape reproduction circuit 6, optical disc reproduction circuit 9, and external input terminals 4 and 5 are each inputted to a two-channel signal switching circuit 12 (illustrated with thin solid lines in FIG. 1). The microcomputer 1 control such that the audio signals of the audio output circuit selected in response to the selection signal transmitted from a non-illustrated remote control unit, that is selectively operated by an operator, are outputted from the circuit 12 to a surround-processing circuit 13.

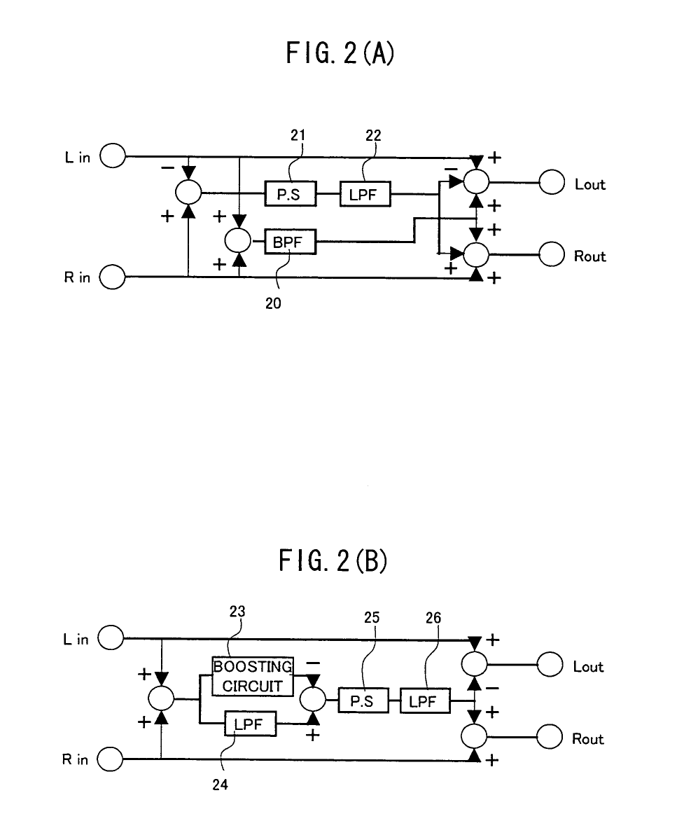

The surround-processing circuit 13 processes the audio signals outputted from the circuit 12 in the stereo mode, when the audio signals are the stereo two-channel signals. The circuit 13 processes in the monaural mode when the audio signals are the monaural signal, and outputs the result to a multi-channel signal switching circuit 14 as the audio signals being reproducible in the multi-channels. With regard to the processing method in the stereo mode and the monaural mode, various proposals have already been put forward. As an example, from the consideration that the vocal components in the center channel become comparably weakened when the signals are the stereo signals, as shown in FIG. 2(A), the R-channel audio signal and the L-channel audio signal are added, and the added signal is passed through a band-pass filter 20 covering the vocal frequency band, which is added again to the audio signals for the R channel and L channel. Here in FIG. 2(A), the symbol 21 depicts a phase shifter, and the symbol 22 depicts a filter for a low-frequency band. When the signals are the monaural signal, the same monaural signal is inputted to the R channel and the L channel, as shown in FIG. 2(B). Here, in order to suppress an expansion of the vocal components in reverse, both of the audio signals are added, the added signal is passed through a boosting circuit 23 for a high-frequency band and a filter 24 for a low-frequency band, and an output from the boosting circuit 23 is subtracted from an output from the filter 24, thereby attenuating the vocal frequency band. Here in FIG. 2(B), the symbol 25 depicts a phase shifter, and the symbol 26 depicts a filter for a low-frequency band.

The output signals from the surround-processing circuit 13 and the multi-channel audio signals outputted from the optical disc reproduction circuit 9 are inputted to the multi-channel signal switching circuit 14. The multi-channel signal switching circuit 14 is switched by a command signal from the microcomputer 1, so as to input either one of the output signals from the surround-processing circuit 13 and the multi-channel audio signals outputted from the optical disc reproduction circuit 9 to an amplifier 15. The amplifier 15 delivers the audio signals corresponding to the multi-channels to speakers 16, thereby reproducing the sounds.

The external input terminals 4 and 5 are furnished with a detection circuit 30 that detects the insertion state of a connection plug into the terminal 4. The detection circuit 30 includes a switch 31 electrically connected across the output lines from the external input terminals 4 and 5 to the two-channel signal switching circuit 12. The switch 31 is connected in the normal state, but when a plug is inserted into the terminal 4, the switch 31 is made open. Thereby, the electrically connected state between the two lines is disconnected. To make such a switch that operates to interlock with the insertion state of a plug, it is only needed to use an elastic member in an operating member, to make the tip of the inserted plug operate the operating member, and to release the contacts electrically. When the plugs are inserted into the terminals 4 and 5, the switch 31 is made open, and the two output lines are electrically disconnected. Thereby, the audio signals for the R channel and L channel are outputted to each of the output lines from the plugs. And when the plug is inserted into the terminal 4 only, the switch 31 maintains the connection state, accordingly the monaural signal from the plug is outputted to the two output lines, and the R channel and the L channel shares the same monaural signal.

Further, the detection circuit 30 has a power supply connected to the output line of the terminal 4, and a switch circuit 32 that is turned ON and OFF by a current flown in from the output line of the terminal 5; while the switch 31 is connected, the current is flown into the switch 32 to turn it ON, and while the switch 31 is disconnected, the current is not flown into the switch 32 to turn it OFF. Thus, when the switch 32 is turned ON, the monaural signal is outputted, and when it is turned OFF, the stereo signals are outputted. This means that the monaural signal or the stereo signals can be detected by the ON/OFF of the switch 32. The detection signal from the detection circuit 30 is outputted to the microcomputer 1, in which the stereo signals or the monaural signal are judged.

Signals for identifying the stereo signals or the monaural signal are inputted to the microcomputer 1 also from the radio audio demodulation circuit 2, TV audio demodulation circuit 3, videotape reproduction circuit 6, and optical disc reproduction circuit 9 (the signals are shown with the thick solid lines). The microcomputer 1 outputs a control signal to the surround-processing circuit 13 in response to the detection signal from the detection circuit 30 and these identifying signals, so that the surround-processing circuit 13 starts the stereo or monaural processing.

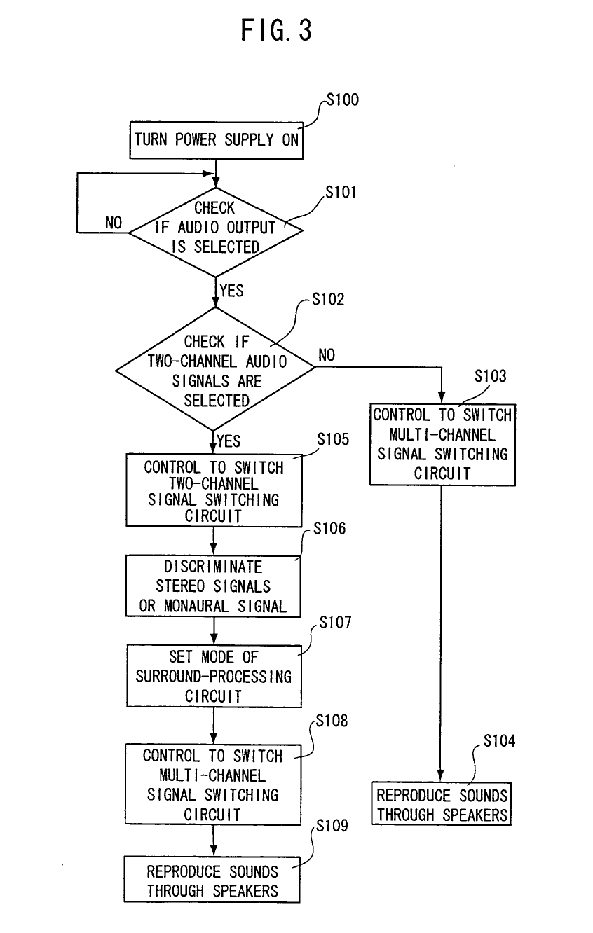

FIG. 3 illustrates the processing flow of the audio output control circuit being thus described. As the power supply is turned ON (S100), the microcomputer 1 checks whether the audio output is selected (S101). If the operator makes a selection operation through the remote control unit, the selected signals are inputted to the microcomputer 1, and that the audio output has been selected is checked accordingly. Receiving the selected signals, the microcomputer 1 checks whether they are the two-channel audio signals (S102). If they are not the two-channel audio signals, but the multi-channel signals, the microcomputer 1 controls the multi-channel signal switching circuit 14, so that the multi-channel signals from the optical disc reproduction circuit 9 are inputted to the amplifier 15 (S103). And, the speakers 16 reproduce the sounds based on the multi-channel signals from the optical disc reproduction circuit 9 (S104).

When the two-channel audio signals are selected in S102, the microcomputer 1 controls the two-channel signal switching circuit 12, so that the selected two-channel audio signals are inputted to the surround-processing circuit 13 (S105). And, the microcomputer 1 discriminates whether the selected two-channel audio signals are the stereo signals or the monaural signal (S106), and sets the surround-processing circuit 13 to the stereo mode or monaural mode (S107). Next, the microcomputer 1 controls multi-channel signal switching circuit 14 so that the output signals from the surround-processing circuit 13 are inputted to the amplifier 15 (S108). And, the speakers 16 reproduce the sounds based on the output signals from the surround-processing circuit 13 (S109).

What is claimed is:

1. An audio output control circuit comprising:
two external input terminals each corresponding to R channel and L channel;
a detection circuit that detects an insertion state of a plug into one terminal of the external input terminals;
a surround-processing circuit that processes audio signals outputted from the external input terminals so as to be reproducible in a surround-sound field; and
a control circuit that controls the audio signals from the external input terminals in response to a detection signal from the detection circuit, so that the surround-processing circuit processes the audio signals in a stereo mode or a monaural mode.

2. An audio output control circuit comprising:
plural types of stereo signal output circuits that output R-channel and L-channel audio signals;
two external input terminals each corresponding to the R channel and L channel;
a detection circuit that detects an insertion state of a plug into one terminal of the external input terminals;
a surround-processing circuit that processes the R-channel and L-channel audio signals so as to be reproducible in a surround-sound field;
a two-channel signal switching circuit that switches the audio signals outputted from the stereo signal output circuits or the external input terminals to output to the surround-processing circuit; and
a control circuit that controls to switch the two-channel signal switching circuit in response to a selection signal for selecting either of outputs from the stereo signal output circuits and the external input terminals, and that controls the audio signals from the external input terminals in response to a detection signal from the detection circuit, so that the surround-processing circuit processes the audio signals in a stereo mode or a monaural mode.

3. An audio output control circuit comprising:
plural types of stereo signal output circuits that output R-channel and L-channel audio signals;
two external input terminals each corresponding to the R channel and L channel;
a detection circuit that detects an insertion state of a plug into one terminal of the external input terminals;
a multi-channel signal output circuit that outputs audio signals corresponding to multi-channels;
a surround-processing circuit that processes the audio signals outputted from the stereo signal output circuits or the external input terminals so as to be reproducible in a surround-sound field;
a two-channel signal switching circuit that switches the audio signals outputted from the stereo signal output circuits or the external input terminals to output to the surround-processing circuit;
a multi-channel signal switching circuit that outputs to switch the audio signals outputted from the multi-channel signal output circuit or the surround-processing circuit; and
a control circuit that controls the two-channel signal switching circuit and the multi-channel signal switching circuit in response to a selection signal for selecting any of outputs from the stereo signal output circuits, the external input terminals, and the multi-channel signal output circuit, and that controls the audio signals from the external input terminals in response to a detection signal from the detection circuit, so that the surround-processing circuit processes the audio signals in a stereo mode or a monaural mode.

4. An audio output control circuit as claimed in claim 1, further comprising a switch between the two external input terminals, which normally puts the two terminals electrically into a connection state, and disconnects the terminals to interlock with the insertion of a plug into one of the terminals, wherein, when the plug is inserted into the other terminal only, a monaural signal from the outside is outputted from the two terminals as the audio signals.

5. An audio output control circuit as claimed in claim 4, wherein the detection circuit detects a connection or disconnection of the switch.
